(19) United States
(12) Patent Application Publication
(10) Pub. No.: US 2016/0255025 A1
(43) Pub. Date: Sep. 1, 2016

(54) SYSTEMS, METHODS AND COMPUTER READABLE MEDIA FOR COMMUNICATING IN A NETWORK USING A MULTIMEDIA FILE

(71) Applicant: NATHAN VALVERDE, BOSTON, MA (US)

(72) Inventors: Nathan Valverde, Boston, MA (US); Victor Guerrero, Scottsdale, AZ (US); Matthew Tanquary, Queen Creek, AZ (US)

(21) Appl. No.: 14/987,408

(22) Filed: Jan. 4, 2016

Related U.S. Application Data
(60) Provisional application No. 62/099,573, filed on Jan. 4, 2015.

(51) Int. Cl. H04L 12/58; H04L 29/08; G06F 17/22; G06F 3/0482; G11B 27/30

(52) U.S. Cl. CPC H04L 51/10; G06F 3/0482; G11B 27/3036; G06F 17/2247; H04L 67/06; H04L 51/32; H04L 67/02

(57) ABSTRACT

Exemplary embodiments provide methods, systems and computer readable media for communicating over a network using a multimedia file are disclosed. A first client device including a user interface is provided for receiving a search term in a search field. The search term corresponds to a song or musical work. The search term is analyzed and a list of multimedia files matching the search term is generated and displayed in the user interface. A multimedia file is selected from the list and a graphical representation of the selected multimedia file is also displayed in the user interface. A portion of the multimedia file is selected and transmitted to a second client device for execution on the second client device. The selected portion of the multimedia file may be executed on the first client device for preview before transmitting to the second client device over the network.

### RELATED APPLICATIONS

This application claims benefit of and priority to U.S. Provisional Patent Application No. 62/099,573, filed Jan. 4, 2015, entitled “A Method for Associating Text with Time Segments of a Media File and Enabling the Media File to be Performed While Displaying the Associated Text”, which is incorporated herein by reference in its entirety.

### BACKGROUND

Users employ various methods to communicate with other users via various messaging platforms. For example, users may communicate using text, images, voice notes, and other mediums of communication. Such users typically communicate using their original words and images. Some users use graphics interchange format (GIF) to combine images and text to communicate with other users in a social media platform, virtual environments or elsewhere on the World Wide Web. The use of pre-existing multimedia files to communicate in a social media platform has been generally limited to using text and images, in combination or separately.

### SUMMARY

Described in detail herein are methods, systems, and computer readable medium for a multimedia communication system for communicating over a network using multimedia files. Further, methods, systems and computer readable medium for associating text with time segments (i.e. a portion of time) of a multimedia file and enabling the multimedia file to be performed while displaying the associated text are described in detail herein. Example embodiments also provide for rendering a user interface on a client device for communicating over a network using multimedia files. As used herein, a time segment may be a portion of a multimedia file with a duration of one, two, three, four, five, six, or any duration of the total length of a song or musical work in seconds that is less than the total length of the song or musical work.

### BRIEF DESCRIPTION OF DRAWINGS

Some embodiments are illustrated by way of example in the accompanying drawings and should not be construed to limit the present disclosure:

FIG. 1 is a block diagram depicting a system for communicating over a network using a multimedia file, according to an example embodiment;

FIG. 2 is a block diagram depicting a system for communicating over a network using multimedia files on a mobile device, according to an example embodiment;

FIG. 3 is a multimedia communication system implemented in modules, according to an example embodiment;

FIG. 4 is a diagrammatic representation of a machine in the example form of a computer system within which a set of instructions for causing the machine to perform any one of the methodologies discussed herein may be executed, according to an example embodiment;

FIG. 5 is a flowchart illustrating steps of an exemplary multimedia communication system, according to an example embodiment;

FIG. 6 is a block diagram of an exemplary computing device that may be used to implement exemplary embodiments of the cash deposit system described herein;

FIG. 7 is a schematic for a user interface for a multimedia communication system, according to an example embodiment; and

FIG. 8 is a block diagram of an exemplary multimedia communication system, according to an exemplary embodiment.

### DETAILED DESCRIPTION

The multimedia communication system described herein enables a user to communicate with other users via at least a portion of a multimedia file. For example, a user may want to communicate with another user via a portion of a song or a portion of a song lyric. The multimedia communication system enables the user to search for a song, and provide the lyrics of the song to the user. The user may select a portion of the song that he or she wishes to communicate to a recipient user. The recipient user, via the multimedia communication system, can play the portion of the song communicated to him or her. While playing the received portion of the song, the recipient user is able to read the corresponding song lyrics synchronously while listening to the song audio. In this manner, the multimedia communication system enables communications between users using songs and musical works, and allows a user to express themselves via songs or musical works. Traditional social media platforms only allow a user to use text or images to communicate. While the multimedia communication system enables a user to use songs, musical works in conjunction with song lyrics to communicate with each other.

In an example embodiment, a plurality of multimedia or media files corresponding to musical works or songs are stored in a database and/or server and are available via the user interface on the client device. Each one of the multimedia files may include an audio file (e.g., .MP3, .MP4, .WAV, .AAC, .WMA, .AIFF, .OPUS, etc.) and a text file (e.g., .DOC, .TXT. etc.) corresponding to the lyrics of musical works or songs. A multimedia file may be a file comprising a combination more than one form of electronic communication. For example, a multimedia file may be an Extensible Markup Language (XML) or HyperText Markup Language (HTML) file used to create common information formats and share both the format and the data on the World Wide Web, intranets and elsewhere using standard ASCII text. Exemplary embodiments further provide for a portion of the multimedia file to be selected and then transmitted from a first client device to a second client device over a network for execution via a user interface of the second client device and vice versa. The multimedia communication system described herein can allow a user to communicate with others via a new social media platform corresponding to the multimedia communication system, or allow a user to communicate with others via existing social media platforms (e.g., Facebook, Twitter™, Instagram, and the like). The multimedia communication system may be provided as an application (i.e. app) that a user can download on to his or her client device.

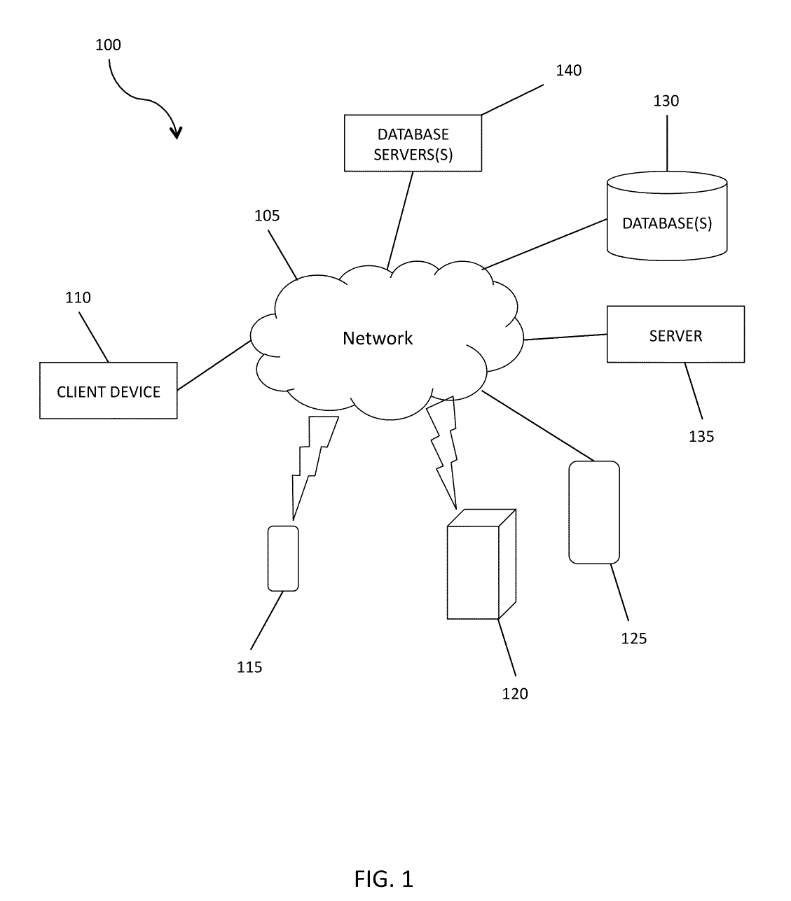

FIG. 1 illustrates a network diagram depicting a system 100 for communicating in a network using multimedia file(s), according to an example embodiment. The system 100 can include a network 105, a client device 110, a client device 115, a client device 120, a client device 125, a database(s) 130, a server 135, and database server(s) 140 is in communication with the network 105. The client device 110, 115, 120, 125, database(s) 130, server 135, and database server(s) 140 may be in communication via the network 105, according to an exemplary embodiment.

In an example embodiment, one or more portions of a network 105 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The client device 110, 115, 120, 125 may comprise, but are not limited to, work stations, computers, general purpose computers, Internet applications, hand-held devices, wireless devices, portable devices, wearable computers, cellular or mobile phones, portable digital assistants (PDAs), smart phones, smart watches, computer systems installed in vehicles, tablets, ultrabooks, netbooks, laptops, desktops, multi-processor systems, microprocessor-based or programmable consumer electronics, game consoles, set-top boxes, network PCs, mini-computers, and the like. Each of client device 110, 115, 120, 125 may connect to network 105 via a wired or wireless connection. Each of client device 110, 115, 120, 125 may include one or more applications (also referred to as “apps”) such as, but not limited to, a web browser, a messaging application, an electronic mail (e-mail) application, a notification application, a multimedia application, a multimedia communication application (corresponding to the multimedia communication system described herein), a social media platform application, and the like. In some embodiments, the multimedia communication application may be included in any of the client devices 110, 115, 120, 125 and may be configured to locally provide a user interface, locally perform the functionalities described herein, and communicate with network 105, on an as needed basis, for data not locally available (such as accessing multimedia files and/or a social media platform using user account information). The client device 110, 115, 120, 125 may correspond to a first client device or a second client device that, respectively, displays a first user interface or a second user interface.

In other embodiments, a multimedia communication application may be included in a memory of client device 110, 115, 120, 125, and the server 135 may perform one or more of the functionalities described herein, while the client device 110, 115, 120, 125 may perform the other functionalities. The server 135 may retrieve a multimedia file from a database, and display graphical representations of the multimedia file on the client device 110, 115, 120, 125, while the client device 110, 115, 120, 125 may receive a search term, receive an input selecting a portion of the graphical representation of the multimedia file. The server 135 may also facilitate access to a social media platform. A search term may be a specific word or phrase used in a database search and may include. The search term may also include one or more terms or words and may contain Boolean operators like OR, AND, NOT, etc.

Each of the database(s) 130, server 135, and database server(s) 140 is connected to the network 105 via a wired connection. Alternatively, one or more of the database(s) 130, server 135, or database server(s) 140 may be connected to the network 105 via a wireless connection. Although not shown, database server(s) 140 can be (directly) connected to database(s) 130, or server 135 can be (directly) connected to the database server(s) 140 and/or database(s) 130. Server 135 comprises one or more computers or processors configured to communicate with client devices 110, 115, 120, 125 via network 105. Server 135 hosts one or more applications or websites accessed by client devices 110, 115, 120, 125 and/or facilitates access to the content of database(s) 130. Database server(s) 140 comprises one or more computers or processors configured to facilitate access to the content of database(s) 130. Database(s) 130 comprise one or more storage devices for storing data and/or instructions for use by server 135, database server(s) 140, and/or client devices 110, 115, 120, 125. Database(s) 130, server 135, and/or database server(s) 140 may be located at one or more geographically distributed locations from each other or from client devices 110, 115, 120, 125. Alternatively, database(s) 130 may be included within server 135 or database server(s) 140.

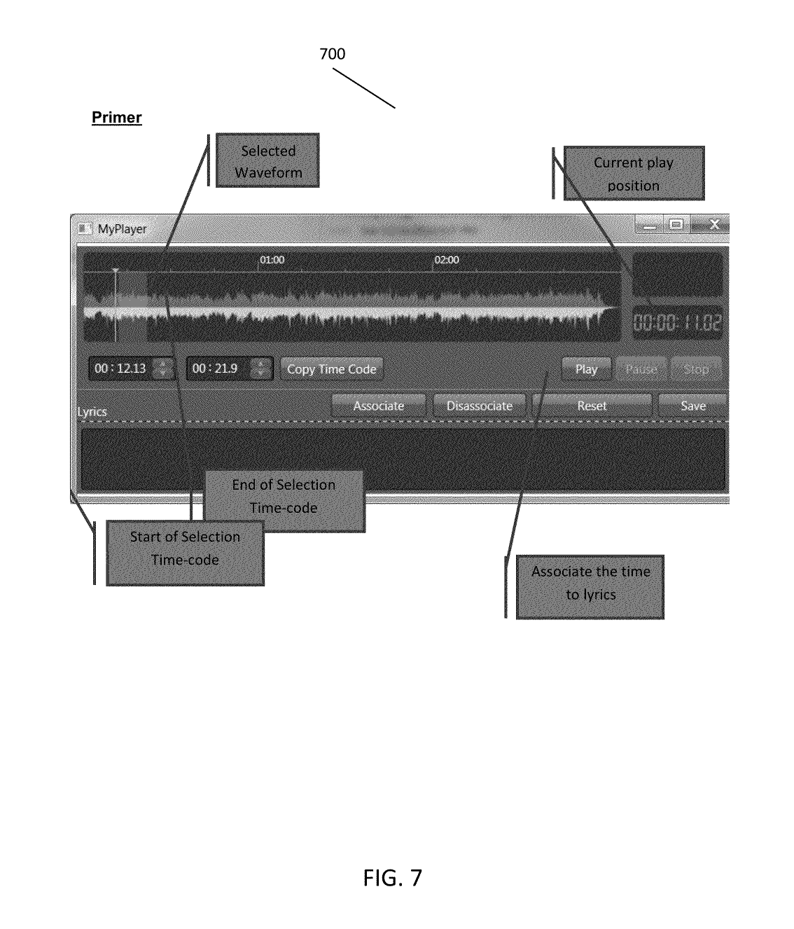

In another embodiment, the multimedia communication application included in any of the client devices 110, 115, 120, 125 may be configured to locally perform some of the functionalities described herein. For example, the client device 110, 115, 120, 125 may include a display device displaying a user interface (e.g., user interface described in connection with FIG. 7) and may include other control mechanisms (e.g., buttons, keyboard, mouse, touch screen, or other input interfaces), and other processing modules. The multimedia communication application may be configured to receive a query or search request corresponding to a song or musical work. The musical work or song may be commercially available, produced or published by a record or publishing company or published by an independent producer or distributor. The search request may be received in a search field in the user interface of the user device. Upon receiving the query or search request, the multimedia communication application may be configured to analyze the query, search the database and generate a list of multimedia files corresponding to the search terms received in the search field. The list may be displayed in the user interface. A user may sort the list using various input controls displayed in the user interface.

Further, in another example embodiment, upon receiving the list of multimedia files, the multimedia communication application may be configured to enable the user to select one of the multimedia files via the user interface on the client device. Once selected, the multimedia communication application may be configured to provide a graphical representation of the multimedia file in the display of the user interface. The graphical representation of the multimedia file may include a display of the text of the song lyrics of the song corresponding to the selected multimedia file. The graphical representation of the multimedia file may also include a display of a waveform illustration of the song corresponding to the selected multimedia file. The multimedia communication application may be configured to execute the multimedia file to play an audio rendition of the song through audio transducers or speakers connected to or in communication with the client device, so that the audio file being played is audible within the approximate vicinity. The multimedia communication application may also be configured to display or highlight the text of the song lyrics in-sync or contemporaneously with the audio being played. The multimedia communication application may be a series or collection of instructions or programming data stored in a memory in communication with the client device. The multimedia communication application may also be software stored in a memory in communication with the client device, that when executed by a processor, performs the steps of the methods described herein.

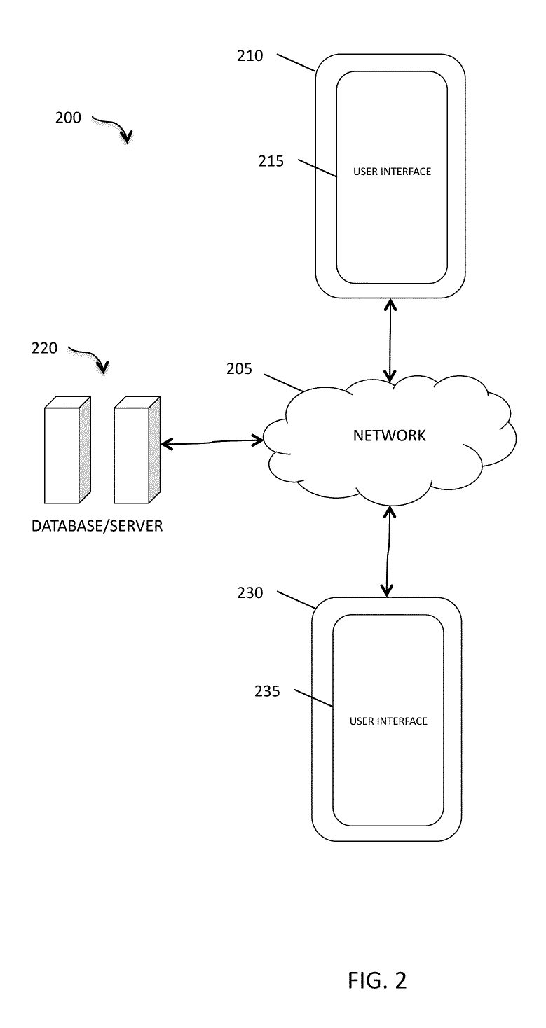

FIG. 2 illustrates a network diagram depicting a system 200 for communicating over a network using multimedia file(s), according to an example embodiment. The system 200 may include a network 205, client device 210, database/server 220, and client device 230. In accordance with this aspect of the disclosure, the user interface module or user interface 215, 235 may be operable by the at least one processor to output, for display, a graphical user interface or user interface 215, 235 of an application. The graphical user interface 215, 235 may be configured to receive a search term entry corresponding to a song or musical work, the song or musical work being associated with a multimedia file stored in a database/server 220. The graphical user interface 215, 235 may further be configured to provide, in a display of the graphical user interface 215, 235, a list of multimedia files matching the song or musical work.

The client device 210, 230 may include at least one processor, and a user interface module 215, 235 operable by the at least one processor. Each client device 210, 230 may either be a transmitting client device or a recipient client device, depending on which device initiates the search for a song to select a portion to be transmitted to the other device, according to an example embodiment. The system 200 may be configured to receive a search term in the client device 210, wherein the search term corresponds to a song or musical work. The database/server 220 may be configured to store a plurality of multimedia files, each one of the plurality of multimedia files corresponding to a unique song or musical work, each corresponding unique song or musical work being different from each of the other remaining unique songs or musical works. For example, for each one of the plurality of multimedia files, there is only one corresponding song or musical work. Upon receiving the search term in the user interface 215, 235 of the client device 210, 230, the processor may be configured to search the database/server 220 for the multimedia file corresponding to the search term and generate a list of one or more matching multimedia files in the user interface 215, 235 of the client device 210, 230. The client device 210, 230 may be configured to enable the selection of one of the matching multimedia files, and generate a graphical representation of the multimedia file on the interface 215, 235 via information stored in the multimedia file. The user interface 215, 235 may also be configured to enable selection of a portion of the graphical representation of the multimedia file for preview or execution on the client device of which the search was performed. Once the portion of the graphical representation is selected, the client device 210, 230 may be configured to transmit, via the network 205, the selected portion of the graphical representation to a recipient/second client device 210, 230 in communication with the network 205.

The recipient client device 210, 230 may be configured to receive and execute the transmitted portion of the graphical representation of the selected multimedia file, wherein upon execution, the portion of the graphical representation is generated on a display of the user interface of the recipient/second client device 210, 230. Further, the recipient/second client device 210, 230 may be configured to play the corresponding audio of the portion of the transmitted multimedia file on speakers or sound transducers in communication with the recipient client device 210, 230.

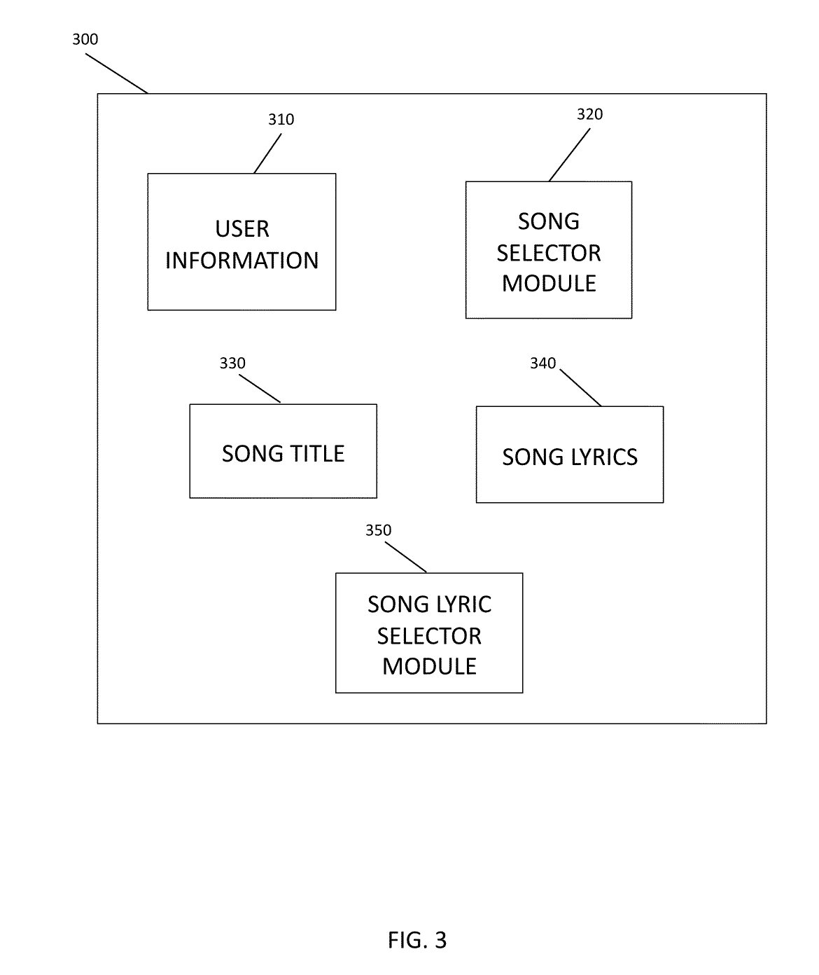

FIG. 3 is a block diagram showing a multimedia communication system 300 implemented in modules, according to an example embodiment of the present disclosure. The system 300 may include a user information module 310, a settings module 320, a song selector module 330, a song title module 340, a song lyrics module 350 and a song lyric selector module 360. The multimedia communication system 300 may allow a user to communicate with other users via a new social media platform or existing social media platforms.

The user information module 310 may be configured to receive information to authenticate access to the system 300 via a user interface (for example, the user interface described in connection with FIG. 7). The user information module 310 may also be configured to receive information to authenticate access into the multimedia communication application. For example, the user information module 310 may provide a user name and password entry field. In an example embodiment, the first time a user logins, the user name and user password may be generated by the server and/or the multimedia communication application. User information may include a user name, user password, user address, user date of birth, user gender, user phone number, user country of residence, user security questions, user e-mail address, etc.

The song selector module 330, in response to executing instructions stored in memory by a processor, may be configured to receive a search term, generate a list of multimedia files corresponding to the search term, enable the selection of at least one of the multimedia files and generate a graphical representation of the selected multimedia file in the user interface 300.

The song lyrics module 340 may be configured to display the lyrics of a musical work or song associated with the multimedia file for viewing on a user interface.

The song lyric selector module 350 may be configured to enable the selection of a portion of the song lyrics that may be displayed by the song lyrics module 340 in the user interface. For example, the song lyric selector module 350 may generate a graphical representation of the lyrics of the song so that a portion of the song lyrics may be selected by receiving an input from a touch screen (tapping and dragging to highlight), a mouse selection (clicking and dragging to highlight), a keyboard selection (using arrows and shift key to highlight and enter key to finalize selection) or a voice command selection (making a vocal commands).

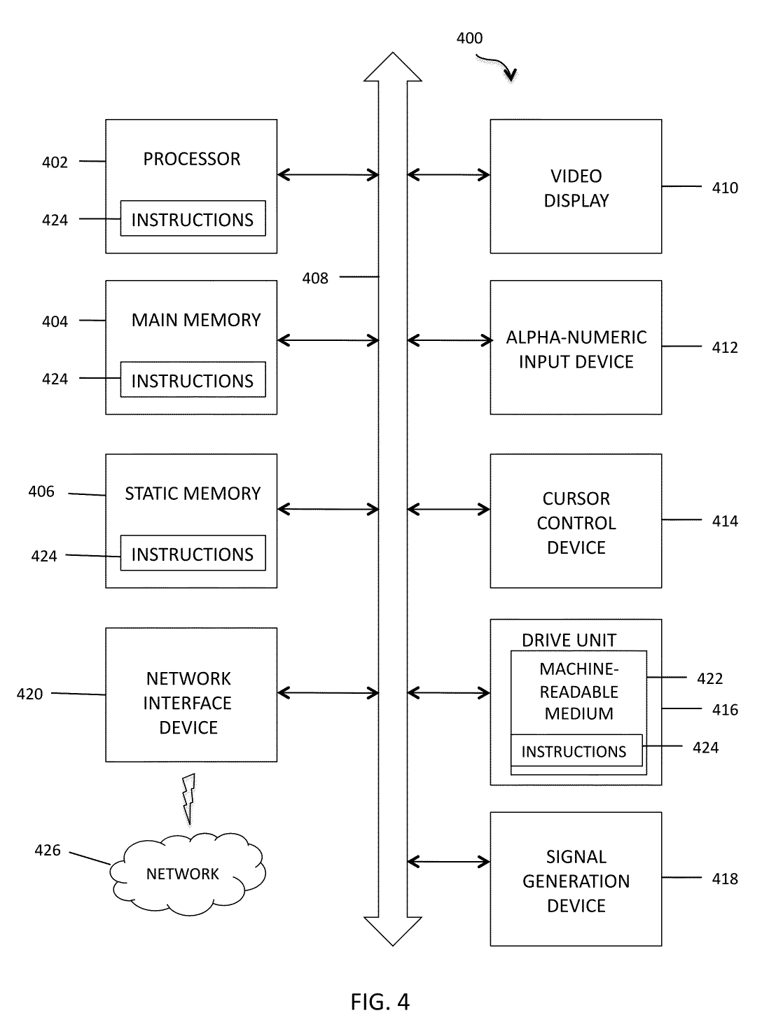

FIG. 4 is a block diagram of machine in the example form of a computer system 400 within which instructions, for causing the machine (e.g., client device 110, 115, 120, 125; server 135; database server(s) 140; database(s) 130) to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD), a touch screen, or a cathode ray tube (CRT)). The computer system 400 also includes an alphanumeric input device 412 (e.g., a physical or virtual keyboard), a user interface (UI) navigation device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions and data structures (e.g., software) 424 embodying or used by any one or more of the methodologies or functions described herein. The instructions 424 may also reside, completely or at least partially, within the main memory 404, static memory 406, and/or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 424 may further be transmitted or received over a communications network 426 using a transmission medium. The instructions 424 may be transmitted using the network interface device 420 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

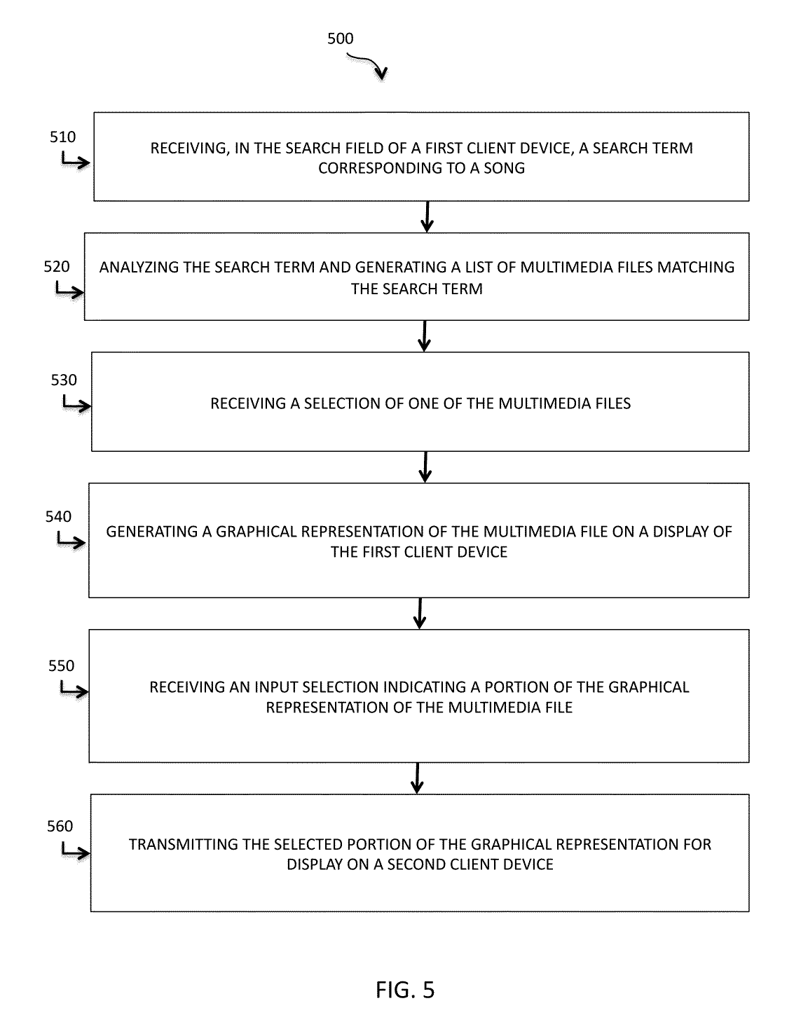

FIG. 5 illustrates a flowchart of a method 500 for communicating over a network using a multimedia file, according to an example embodiment. The method 500 includes receiving, in a search field on a first client device, a search term related or corresponding to a song (step 510). Receiving a search term in a search field may include receiving text from an input device or receiving audio input from a microphone in communication with the first client device. The search term may include text corresponding to a song title, artist, genre of music, album, soundtrack, movie or movie soundtrack, composer, DJ, producer, episode, show, season, or any other song information category describing a song or musical work or relating to a song or musical work.

At step 520, the song selector module 320 analyzes and retrieves a multimedia file from a database that matches the search term. Analyzing the multimedia file may include scanning the multimedia file to determine the information stored or embedded within the multimedia file. Each multimedia file may include all information that may be used to identify the multimedia file or to distinguish the multimedia file from other multimedia files. The database may comprise a plurality of multimedia files corresponding to songs or musical works. The database may be updated with new or additional multimedia files over time. A system administrator or other administrators with absolute system authorization may modify or update the multimedia files. As new songs or musical works are released from the respective record companies or independent distributors, those songs or musical works may be combined with text files including the corresponding song lyrics to create the multimedia files and may be added to the database and made available for search and use on each client device. Retrieving a multimedia file from a database that matched the search term may include analyzing the database including the multimedia files and determining information stored in each of the plurality of multimedia files. The information stored in each of the plurality of multimedia files may include song title, artist or group name, genre of music, album, soundtrack, movie or movie soundtrack, composer, DJ, producer, episode, show, season, or any other song information category describing the song or musical work or corresponding or relating to the multimedia file. The search term matches the multimedia file if any of the information (e.g. song title, artist, genre of music, album, soundtrack, movie or movie soundtrack, composer, DJ, producer, episode, show, season, etc.) included in the multimedia file is the same or similar to the search term.

Further, the method 500 may include receiving a selection of one of the multimedia files (step 530). The multimedia file selection may include receiving an input from a touch screen (tapping with fingers or a stylus), a mouse selection (clicking), a keyboard selection (using arrows, tab or shift key and enter key to finalize selection) or a voice command selection (using vocal commands) wherein one of the multimedia files is selected out of the list of multimedia files.

Upon receiving the selection of one of the multimedia files, the method 500 may further include generating a graphical representation of the multimedia file (step 540). Generating a graphical representation of the multimedia file may include producing an image on the user interface display of the client device, wherein the image comprises an illustration of a frequency compilation of the audio portion of the multimedia file. For example, the frequency compilation may be a waveform graphical representation or waveform image of the audio file. The waveform graphical representation or waveform image may be in color or in black and white, wherein the color variations may identify the frequency variations of the audio file. The waveform graphical representation or waveform image may also indicate portions of the audio file where the decibel levels may vary indicating lower and higher sound levels so as to identify where certain portions of the song may begin or end. Generating a graphical representation of the multimedia file may also include producing text indicating the lyrics of the song corresponding to the selected multimedia file. The text including the song lyrics may be displayed in a text display in the user interface of the client device.

The method 500 may also further include receiving an input selection of a portion of the graphical representation of the multimedia file (step 550). At step 550, the song lyric selector module 350 receives an input selecting a portion of a graphical representation of the multimedia file. Selecting a portion of the graphical representation of the multimedia file may include receiving a selection of a portion of the waveform image or receiving a selection of a portion of the song lyrics of the text display. The input selection may include receiving an input from a touch screen (tapping and dragging to highlight), a mouse selection (clicking and dragging to highlight), a keyboard selection (using arrows and shift key to highlight and enter key to finalize selection) or a voice command selection wherein a portion of the graphical representation of the multimedia file is selected. The input selection indicating a portion of the graphical representation of the multimedia file may be stored in a memory on the client device, on the server and/or on the database. Once stored, the input selections or selected portions of the multimedia files may be available for use at a later time or provided in a list of previously used/selected or input selections. The input selections or selected portions of the multimedia files may also be marked as favorites to be included in a list of favorite portions of multimedia files, wherein the list of favorites may be made available for future use.

In some embodiments, the multimedia file, or at least a portion thereof, may be executed on the first client device. The multimedia file, as described herein, may include a text file comprising song lyrics corresponding to a song. As also described herein, the multimedia file may include an audio file comprising audio corresponding to the song. Upon execution, the song lyrics of the multimedia file may be played on speakers or audio transducers in communication with the first client device. Further, song lyrics or the portion of the song lyrics of the multimedia file may be generated on a display of the user interface of the first client device. The multimedia file, or a portion thereof, may be executed on the first client device for preview before being selected for transmission over the network to a second/recipient client device.

The method 500 may also include transmitting the selected portion of the graphical representation for execution on a second client device (step 560). Transmitting the selected portion of the graphical representation may include establishing a connection with a multimedia communication application network, authenticating the client device with the multimedia communication application, selecting a second user device in communication with the multimedia communication application network, and electronically transmitting the portion of the graphical representation of the multimedia file over the network via the multimedia communication application network to a second client device. The multimedia communication application network may be in communication with the network or may exist within the network.

According to another example embodiment, the method may further include receiving the selected portion of the graphical representation of the multimedia file in the second client device. For example, the second client device may be in communication with the network via the multimedia communication application network. The second client device may be authenticated with the multimedia communication application similar to how the first client device is authenticated. Once the second client device is in communication with and authenticated by the multimedia communication application, the second client device may receive the selected portion of the graphical representation of the multimedia file transmitted by the first user device.

The method may further include executing the selected portion of the graphical representation on the second client device, wherein executing may include displaying text indicating the lyrics of the song corresponding to the portion of the graphical representation of the multimedia file, displaying the audio waveform of the portion of the graphical representation of the multimedia file and audibly playing the audio file of the portion of the graphical representation of the multimedia file on speakers or audio transducers in communication with the second client device. Displaying text indicating the lyrics of the song and audibly playing the audio file may be executed synchronously such that the text of the lyrics may flow in one direction or be distinguished from the other lyrics at the same time as the corresponding lyrics are audibly played on the speakers or audio transducers. As a result, the effect is the text of the song lyrics are presented at the same time as the corresponding song lyric is audibly played from the speakers or audio transducers.

In another example embodiment, the method may include receiving a search term via a user interface on a first client device, analyzing the search term and retrieving one or more multimedia files from a database based on the analysis of the search term, generating a list using the retrieved one or more multimedia files and displaying the list of multimedia files in the user interface on the first client device. The method may further include receiving an input selecting a multimedia file from the list of multimedia files, generating a graphical representation corresponding to the selected multimedia file, wherein the graphical representation may include an audio waveform of the audio file included in the multimedia file and a text display of the lyrics of the audio file included in the multimedia file. The method may also further include storing the selected portion of the graphical representation of the multimedia file, and transmitting the selected portion of the multimedia file corresponding to the selected portion of the graphical representation for display on a second client device via a user interface on the second client device.

In another example embodiment, the method for communicating in a network using song lyrics is described. The method may comprise rendering a user interface on a first client device. The user interface may include at least one search field for receiving a search term or search terms, wherein the search term(s) correspond to a song title, song artist or any other term relating to a song. The method may further include providing a multimedia database comprising a plurality of multimedia files, each one of the plurality of multimedia files corresponding to a matching song of a plurality of songs. Further, each one of the plurality of multimedia files may include an audio file and a text file, the text file having a string of text corresponding to the matching song. The method may further include receiving in the at least one search field a search term corresponding to at least one of the plurality of songs. In response to receiving the search term, the method may further include querying the multimedia database for at least one of the plurality of multimedia files corresponding to the search term; providing on a display of the user device, a graphical representation of at least one of the plurality of multimedia files corresponding to the search term; configuring the user interface to enable the user to select a matching multimedia file corresponding to the search term from the graphical representation; in response to the user selecting the matching multimedia file, displaying a waveform graphical representation superimposed proximate to the string of text on the display; receiving input from the user indicating a selection of the waveform graphical representation, the selection corresponding to a snippet comprising an audio file portion and a text string portion of the song; storing the selection of the waveform graphical representation in a client database; receiving a request from the user to communicate with a social network and at least one of a plurality of associated social network users in communication with the social network; transmitting the selection of the waveform graphical representation over a social media network to at least one of a plurality of associated social media network users; displaying the selection of the waveform graphical representation to at least one of the plurality of associated social network users; and transmitting, via a speaker associated with the user device, sound waves for the song corresponding to the portion of the graphical representation and displaying text indicating the lyrics of the song corresponding to the portion of the graphical representation. The client database may be on the client device or may be in the database/server.

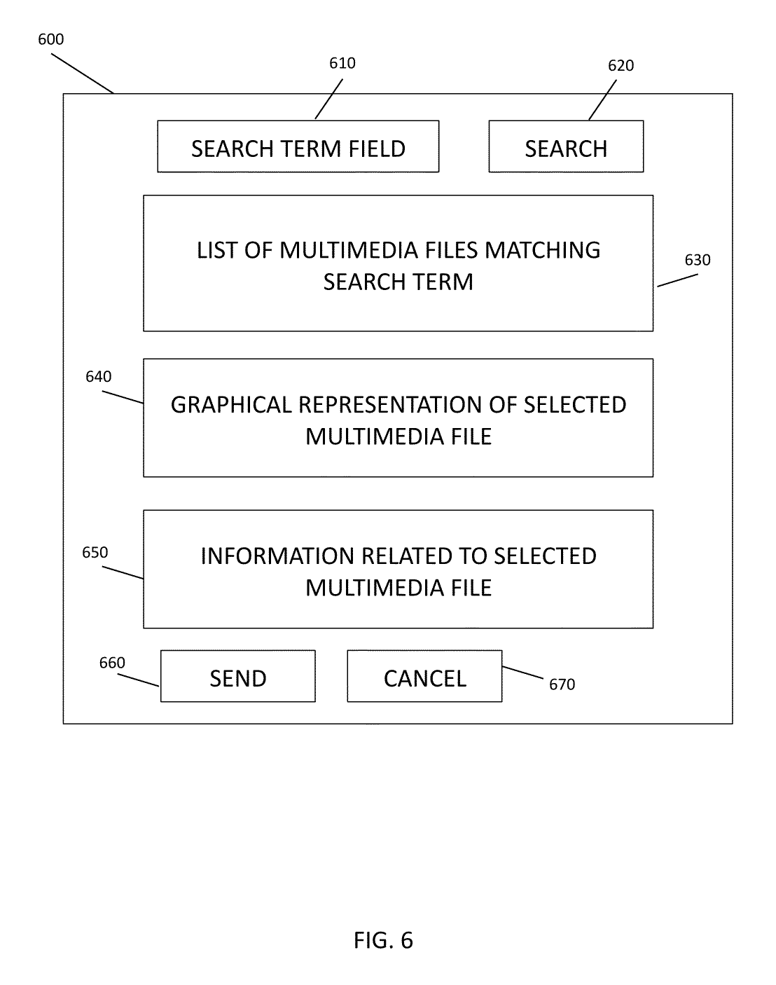

FIG. 6 is a schematic of an example user interface 600 for the multimedia communication system described herein. As shown, user interface 600 includes a search term field 610, a search button 620, a list 630 for multimedia files matching the search term, a graphical representation 640 of a selected multimedia file, information 650 related to the selected multimedia file, a send button 660, and a cancel button 670.

A user enters one or more search terms in the search term field 610 to search a database storing multimedia files. After entering the search term, the user selects or clicks the search button 620. In response to selection of the search button 620, the multimedia communication system generates the list 630 that contains one or more multimedia files based on analysis of the search term. The user can select a multimedia file from the list 640 (by selecting or clicking on an item in the list 630). In response, the multimedia communication system generates and displays a graphical representation 640 of the selected multimedia file. As described above, the graphical representation may include text corresponding to the lyrics of the song or musical work stored in the multimedia file and/or a sound waveform corresponding to the song or musical work stored in the multimedia file. The user interface 600 can also display information 650 related to the selected multimedia file. Information 650 may include the name of the song or musical work, the name of the multimedia file, the artist corresponding to the song or musical work, and the like. The user interface 600 also includes send button 660, which the user can select or click after a user has selected a portion of the graphical representation 640 to transmit to another user. Selection of the cancel button 670 may allow a user to exit the user interface 600.

In another example embodiment, a method for creating a multimedia file is described. The method may comprise two distinct software methods (collectively referred to as “TT Software”) that when used in conjunction with another, enables a user to synchronize lyrics or text with a specified or pre-selected timeframe of a media file. The first software method is a priming tool that allows the user to play a media file and manually synchronize the lyrics with the associated time frame being played. The resulting file is an “XML” file which is essentially an MP3 file but with added information of the lyrics and the associated time frames at which they are played. The second piece of software is able to read and recognize the XML file and enables a user to select a fragment or portion of the XML file in order to perform the content within the user interface while simultaneously displaying the associated song lyrics or text. The TT software is capable of performing the aforementioned functions with MP3 files but the software can be modified in order to accommodate other types of media such as video and voice recordings.

The multimedia file also referred to as a Lyrics Time Association File (LTA) may be an XML file that may include an audio file and a text file. The method may include coordinating text and musical content in one unified file. The method for coordinating text and musical content in a way that provides a mechanism to facilitate sharing of music from the pre-selected content of lyrical position or waveform position. For example, given an electronic view of lyrics (i.e. text of lyrics) a user might select a section of the text and the correlated music could be copied and delivered apart from the whole MP3 file. Similarly, an arbitrary section of the MP3 could be selected via a waveform representation, which would then provide a listing of lyrics that are precisely aligned with the selected waveform. This method can also be used to coordinate text with other media based content such as videos and other non-MP3 based recordings.

The coordination is managed through the use of an XML file that maps MP3 time-codes to segments of lyric. For example, please see an embodiment of the XML file:

<?xml version=“1.0”?>
<LyricsTimeAssociation
xmlns:xsi=“http://www.w3.org/2001/XMLSchema-
instance” xmlns:xsd=“http://www.w3.org/2001/XMLSchema”>
<CompleteLyrics>[Formatted Lyrics]</CompleteLyrics>
<LyricsTimeAssociationCollection>
<LyricsToTime>
<TimeRangeStart>0h0m00.0s</TimeRangeStart>
<TimeRangeStop>0h0m00.0s</TimeRangeStop>
<TextRangeStart>0</TextRangeStart>
<TextRangeStop>0</TextRangeStop>
<SelectedText>Some text</SelectedText>
</LyricsToTime>
</LyricsTimeAssociationCollection>
</LyricsTimeAssociation>

The root node is LyricsTimeAssociation. This the identifier the XML contains and that the TT Software understands.

CompleteLyrics is an optional node and contains the complete lyrics for the associated MP3.

LyricsTimeAssociationCollection is the container for the Lyrics To Time node collection. Each Lyrics To Time node contains the details for a segment of lyrics and the associated time span within the MP3 file.

TimeRangeStart and TimeRangeStop are the specific time end points that have been identified for a particular chunk of lyrics.

TextRangeStart and TextRangeStop are also used for the TT Software priming tool. They assist the tool by identifying the precise location of the lyrics that it will need to display as completed association.

SelectedText is the chunk or portion of lyrics that have been tagged for the time range.

The XML is associated to an MP3 file through external means. For the purpose of the prototype, the connection is made via the file name and URI. In the case of the prototype, the base file name for the XML file was the same as the base file name for the MP3 file. The association was then made logical through the use of code.

The XML code can also be embedded directly into the MP3 file as extra data, which could be extracted by a software tool designed to find and consume the LyricsTimeAssociation code. These MP3 files can be stored and maintained on servers. User software would be directed at the primed versions of MP3 files created by the TT Software priming tool (primer).

In another example embodiment, a method for creating the LyricsTimeAssociation (LTA) file is described. While the file itself may be simple, it may not be trivial to derive the needed information. For the purposes of the prototype, it was determined that the most reliable method would be through the use of human interaction; although it is conceivable that other methods could be used. To accomplish this, a tool has been developed that is capable of generating the LTA file. This tool is referred to herein as the primer.

FIG. 7 is a block diagram of an example priming tool or primer 700 for synchronizing song lyrics text with a media file according to an example embodiment. The goal of the primer 700 is to convert time-code to a visual form that the user can select and associate to the lyrics. The primer tool is capable of playing the music, displaying the current time code at any given point in the song file and selecting a range of music via waveform display. Once selected, the time range can then be associated to lyrics by highlighting a segment of lyrics and clicking the associate button.

In another example embodiment, the primer tool specifications are described. Components of the primer tool are from the WPFSoundVisualization Library, coupled with the NAudio library; both of which are open source. The programming languages may be C#, xaml, and/or xml. The program saves its output files to a Google Doc repository defined in the code with the appropriate credentials. The MP3 file is then loaded into the player via file location specified as the first parameter of the program launch. (i.e. c:\\myplayer.exe c:\\somefile.mp3)

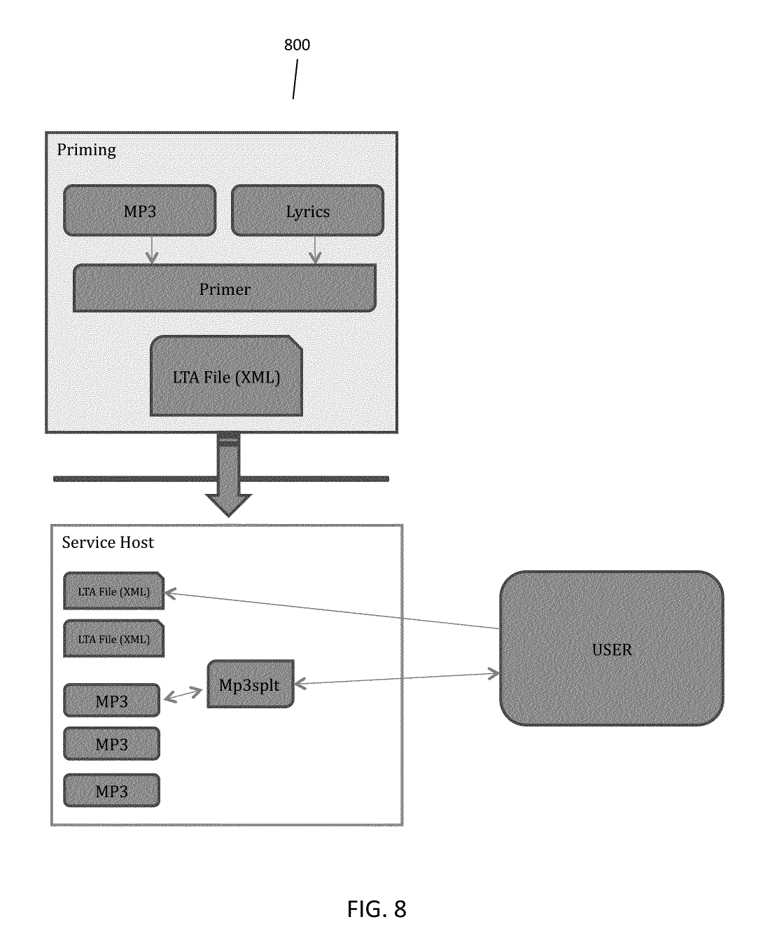

FIG. 8 is a block diagram of another example of an LTA tool 800 for creating a LyricsTimeAssociation (LTA) file according to an example embodiment. In another example embodiment, a method for utilizing the LTA file is described. The LTA file may be designed to provide the details of where a segment of lyrics can be found within an MP3 file. The user can use this information to send to a tool designed to locate the time-code endpoints within an MP3 file and extract that portion of the MP3 file. The extracted portion must remain portable and playable. This is accomplished with a tool called MP3split. To make the usage of the MP3split file accessible to any user, a web service has been developed. The web service provides a simplistic application programming interface API to sending an MP3 split request and receiving sub-portion of the MP3 as specified by the request. The web service is to be hosted on a reliable and scalable public server. For that purpose, Amazon AWS currently hosts the web service. The web service provides a URI endpoint for any user to use for the purpose of extracting a segment of MP3. The URI is currently as follows:

http://ec2-54-191-147-186.us-west-2.compute.amazonaws.com/StreamMp3Segment/[SomeFile].mp3/[a].[b]/[c].[d]]
(The hyperlink differs from the displayed text in the sense that it points to a live and functional sample of the service call)
a: beginning time stamp minutes
b: beginning time stamp seconds
c: end time stamp minutes
d: end time stamp seconds

The service was developed in C# and uses windows WCF libraries to implement the REST protocol. The Mp3 file that is named must exist on the server in the prescribed location per the installation of the web service. It is key that the MP3 files that are housed on the servers are the identical files that were used during the priming phase. Any difference in the file can render the LTA file useless for that MP3.

In another example embodiment, further considerations for all software provided for the prototyping and proof of concept (POC) of TT Software are described. The software provided for the purpose of reducing the prototype to practice and the POC was developed in rapid fashion with no specific or defined requirements for security, high availability, scalability, or any other standard engineering practice that would typically involve a robust development cycle. These additional attributes would not change the basic patentable functionality of the TT Software concept, however. As the TT Software grows organically, it is expected that the typical protective and elastic layers will be built into the system, which will not alter the concept, but rather facilitate its rapid and robust growth. LTA files are simply text files with XML in them. It would be beneficial to store that information in a database instead of a text file for ease of association with MP3 as well as relational query.

According to another example embodiment, the method for communicating over a network using a multimedia file may include rendering a user interface on a display of a user device; configuring the user interface to enable a user to select at least one audio file associated with a song stored in an audio file database; generating a graphical representation of the audio file in the user interface, wherein the graphical representation includes at least two time-indicators indicating a segment of the audio file; configuring the user interface to enable the user to select at least one text file corresponding to the audio file from a text file database, the text file including lyrics of the song in the audio file; displaying the lyrics from the text file in the user interface in a selectable format; configuring the user interface to enable the user to select a portion of the lyrics displayed in the user interface to synchronize the lyrics with one or more of the at least two time-indicators in the graphical representation of the audio file; and saving a combination of the synchronized text file and audio file as a multimedia work in a multimedia work database, wherein executing the multimedia file causes the song audio to be played and the lyrics from the text file to be displayed substantially contemporaneously to match (e.g. parallel, mirror or align) the lyrics of the song audio.

The following description is presented to enable any person skilled in the art to create and use a computer system configuration and related method and article of manufacture to communicate over a network using a multimedia file. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A method for communicating over a network using a multimedia file, the method comprising:
receiving, via a search field in a user interface of a first client device, a search term corresponding to a song;
analyzing the search term and generating a list of multimedia files from a database matching the search term;
receiving a selection of a multimedia file from the list;
generating a graphical representation of the selected multimedia file in the user interface of the first client device;
receiving an input via the user interface selecting a portion of the graphical representation of the multimedia file; and
transmitting the selected portion of the graphical representation for execution on a second client device.

2. The method of claim 1, further comprising rendering the user interface on the first client device, wherein the user interface comprises the search field.

3. The method of claim 1, wherein the database comprises a plurality of multimedia files, each one of the plurality of multimedia files corresponding to a song.

4. The method of claim 3, wherein each one of the plurality of multimedia files comprises an audio file having audio of the song and a text file having song lyrics corresponding to the song.

5. The method of claim 1, wherein generating the graphical representation of the multimedia file includes displaying a waveform image and the song lyrics of the song on the user interface of the first client device.

6. The method of claim 1, further comprising storing the portion of the graphical representation of the multimedia file in a database.

7. The method of claim 1, further comprising executing the selected portion of the graphical representation on the first user device.

8. A system for communicating over a network using a multimedia file, the system comprising:
a database storing a plurality of multimedia files;
a memory;
a processor in communication with the memory and executing instructions to:
receive, via a search field in a user interface of a first client device, a search term corresponding to a song;
analyze the search term and generating a list of multimedia files from the database matching the search term;
receive a selection of a multimedia file from the list;
generate a graphical representation of the selected multimedia file in the user interface of the first client device;
receive an input via the user interface selecting a portion of the graphical representation of the multimedia file; and
transmit the selected portion of the graphical representation for execution on a second client device.

9. The system of claim 8, wherein the process is further configured to render the user interface on the first client device, wherein the user interface comprises the search field.

10. The system of claim 8, wherein each one of the plurality of multimedia files stored in the database corresponds to a song.

11. The system of claim 10, wherein each one of the plurality of multimedia files comprises an audio file having audio of the song and a text file having song lyrics corresponding to the song.

12. The system of claim 8, wherein generating the graphical representation of the multimedia file includes displaying a waveform image and the song lyrics of the song on the user interface of the first client device.

13. The system of claim 8, wherein the process is further configured to store the portion of the graphical representation of the multimedia file in the database.

14. The system of claim 8, wherein the processor is further configured to execute the selected portion of the graphical representation on the first user device.

15. A non-transitory machine-readable medium storing instructions executable by a processing device, wherein execution of the instructions causes the processing device to implement a method for communicating over a network using a multimedia file, the method comprising:
receiving, via a search field in a user interface of a first client device, a search term corresponding to a song;
analyzing the search term and generating a list of multimedia files from a database matching the search term;
receiving a selection of a multimedia file from the list;
generating a graphical representation of the selected multimedia file in the user interface of the first client device;
receiving an input via the user interface selecting a portion of the graphical representation of the multimedia file; and
transmitting the selected portion of the graphical representation for execution on a second client device.

16. The non-transitory machine-readable medium of claim 15, wherein the method further comprises rendering the user interface on the first client device, wherein the user interface comprises the search field.

17. The non-transitory machine-readable medium of claim 15, wherein the database comprises a plurality of multimedia files, each one of the plurality of multimedia files corresponding to a song.

18. The non-transitory machine-readable medium of claim 17, wherein each one of the plurality of multimedia files comprises an audio file having audio of the song and a text file having song lyrics corresponding to the song.

19. The non-transitory machine-readable medium of claim 15, wherein generating the graphical representation of the multimedia file includes displaying a waveform image and the song lyrics of the song on the user interface of the first client device.

20. The non-transitory machine-readable medium of claim 15, wherein the method further comprises executing the selected portion of the graphical representation on the first user device.
